(19) United States
(12) Patent Application Publication
(10) Pub. No.: US 2019/0136604 A1
(43) Pub. Date: May 9, 2019

(54) VEHICLE WINDOW SYSTEM FOR BUFFETING MITIGATION

(71) Applicant: GM GLOBAL TECHNOLOGY OPERATIONS LLC, Detroit, MI (US)

(72) Inventors: Mark A. Stebbins, Bloomfield Hills, MI (US); Joseph A. Schudt, Macomb, MI (US); Matthew Simonin, Ortonville, MI (US); Robert N. Saje, Shelby Township, MI (US)

(21) Appl. No.: 15/806,804

(22) Filed: Nov. 8, 2017

(51) Int. Cl. E05F 15/71; B60J 1/17

(52) U.S. Cl. CPC E05F 15/71; E05Y 2900/55; B60J 1/17

(57) ABSTRACT

An automotive vehicle includes a first movable window selectively covering a first cabin opening and a second movable window selectively covering a second cabin opening. A first actuator is configured to selectively actuate the first movable window and a second actuator is configured to selectively actuate the second movable window. A controller is in communication with a sensor disposed in the cabin and with an HMI configured to receive a window open request from an operator. The controller is configured to, in response to the window open request, control the first actuator to actuate the first movable window from a closed position to an open position, and in response to a signal from the sensor indicating pressure variations exceeding a predefined threshold with the first movable window in the first open position, automatically control the second actuator to actuate the second movable window in an open direction.

### TECHNICAL FIELD

The present disclosure relates to automotive vehicles, and more particularly to window assemblies for automotive vehicles.

### INTRODUCTION

Automotive vehicles are generally provided with a cabin within which occupants may reside. Such cabins are generally provided with one or more windows which may be raised or lowered by the occupants. However, lowering windows while the vehicle is in motion may result in a buffeting or Helmholtz resonance effect within the vehicle. As illustrated in FIG. 1, vortices are formed as air passes over an opening, such as an open side window. When the vortices strike the aft edge of the opening, such as the B pillar in FIG. 1, the vortices cause a pressure wave within the cabin of the vehicle. The rate at which these pressure waves occur is based on vehicle speed relative to the air. As a result, at some vehicle speeds the pressure waves may approach a resonance point. The intensity of sound and pressure near such resonance points may be undesirable for many vehicle occupants.

### SUMMARY

An automotive vehicle according to the present disclosure includes an occupant cabin with a first opening and a second opening, a first movable window selectively covering the first opening and having a first closed position and a first open position, and a second movable window selectively covering the second opening. A first actuator is configured to selectively actuate the first movable window between the first closed position and the first open position, and a second actuator is configured to selectively actuate the second movable window in a second window open direction and in a second window closed direction. A sensor is disposed in the cabin and configured to generate a signal in response to pressure variations. A human-machine interface (HMI) is configured to receive a window open request from an operator, and a controller is in communication with the HMI. The controller is configured to, in response to the window open request, control the first actuator to actuate the first movable window from the first closed position to the first open position, and in response to the signal from the sensor indicating pressure variations exceeding a predefined threshold with the first movable window in the first open position, automatically control the second actuator to actuate the second movable window in the second window open direction.

In an exemplary embodiment, the controller is further configured to, subsequent controlling the second actuator to actuate the second movable window in the second window open direction, in response to the signal from the sensor continuing to indicate pressure variations exceeding the predefined threshold, automatically control the second actuator to further actuate the second movable window in the second window open direction.

In an exemplary embodiment, the controller is further configured to, subsequent controlling the second actuator to actuate the second movable window in the second window open direction, in response to the signal from the sensor continuing to indicate pressure variations exceeding the predefined threshold, automatically control the first actuator to actuate the first movable window to the closed position.

In an exemplary embodiment, the vehicle additionally includes a third movable window selectively covering a third opening, and a third actuator configured to selectively actuate the third movable window in a third window open direction and in a third window closed direction.

In such an embodiment, the controller is further configured to, subsequent controlling the second actuator to actuate the second movable window in the second window open direction, in response to the signal from the sensor continuing to indicate pressure variations exceeding the predefined threshold, automatically control the third actuator to actuate the third movable window in the third window open direction.

In an exemplary embodiment, the sensor includes a microphone.

In an exemplary embodiment, the first movable window is a first side window and the second movable window is a second side window.

A method of controlling a vehicle according to the present disclosure includes providing a sensor configured to detect pressure variations in a vehicle cabin, an actuator configured to control a position of a first vehicle window, and a controller in communication with the sensor and the actuator. The method additionally includes detecting, via the sensor, pressure variations exceeding a predefined threshold. The method further includes, in response to detected pressure variations exceeding the predefined threshold and to a second vehicle window being in an open position, automatically controlling the actuator, via the controller, to open the first vehicle window a predefined distance.

In an exemplary embodiment, the method additionally includes, in response to detected pressure variations exceeding the predefined threshold subsequent the first vehicle window opening the predefined distance, automatically controlling the actuator, via the controller, to open the first vehicle window an additional distance. Such embodiments may additionally include, in response to detected pressure variations increasing subsequent the first vehicle window opening the additional distance, automatically controlling the actuator, via the controller, to close the first vehicle window the additional distance.

In an exemplary embodiment, the method additionally includes providing an additional actuator configured to control a position of a third vehicle window. Such embodiments also include, in response to detected pressure variations exceeding the predefined threshold subsequent the first vehicle window opening the predefined distance, automatically controlling the additional actuator, via the controller, to open the third vehicle window a predefined distance.

In an exemplary embodiment, the method additionally includes providing an additional actuator configured to control a position of the second vehicle window. Such embodiments also include, in response to detected pressure variations exceeding the predefined threshold subsequent the first vehicle window opening the predefined distance, automatically controlling the additional actuator, via the controller, to close the second vehicle window a predefined distance.

In an exemplary embodiment, providing a sensor includes providing a microphone.

A controller for a window assembly for a vehicle according to an embodiment of the present disclosure is programmed to receive a first signal from a sensor, determine a first pressure variation amplitude based on the first signal, and in response to the first pressure variation amplitude exceeding a reference amplitude, communicate a first control signal to an actuator for actuation of a vehicle window.

In an exemplary embodiment, the controller is programmed to determine the first pressure variation amplitude based on the first signal by filtering the first signal for a desired frequency range.

In an exemplary embodiment, the controller is programmed to communicate the first control signal in further response to a window position signal indicating a second vehicle window being in an open position.

In an exemplary embodiment, the first control signal includes a command to open a vehicle window. In such embodiments, the controller may be further programmed to receive a second signal from the sensor subsequent communicating the first control signal, determine a second pressure variation amplitude based on the second signal, and, in response to the second pressure variation amplitude exceeding the reference amplitude, communicate a second control signal including a second command to open a vehicle window. In such embodiments, the controller may be further programmed to receive a second signal from the sensor subsequent communicating the first control signal, determine a second pressure variation amplitude based on the second signal, and, in response to the second pressure variation amplitude exceeding the first pressure variation amplitude, communicate a second control signal including a command to close a vehicle window.

Embodiments according to the present disclosure provide a number of advantages. For example, systems and methods according to the present disclosure may automatically mitigate buffeting caused by opening of a window in an automotive vehicle, thereby increasing occupant satisfaction.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an illustration of a buffeting in a prior art automotive vehicle;

FIG. 2 is a schematic representation of a vehicle according to an embodiment of the present disclosure; and

FIG. 3 is a flowchart representation of a method of controlling a vehicle according to an embodiment of the present disclosure.

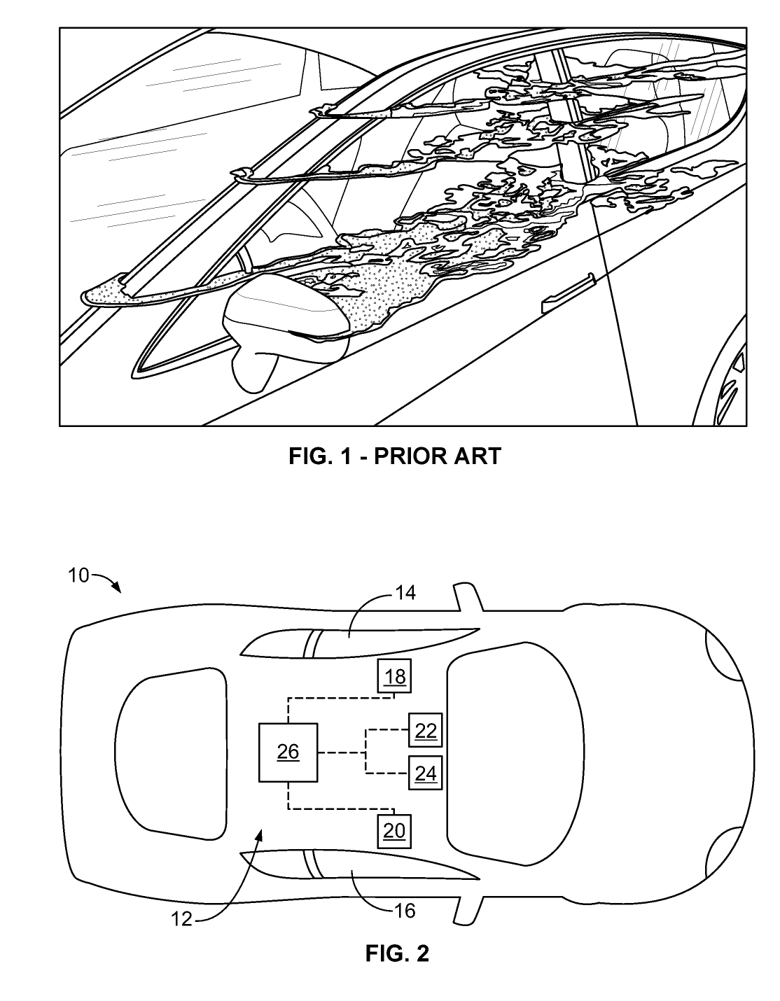

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring now to FIG. 2, a vehicle 10 according to the present disclosure is illustrated. The vehicle 10 has an occupant cabin 12 provided with a first movable window 14 and a second movable window 16. In the illustrated embodiment the first movable window 14 is a driver side window and the second movable window 16 is a passenger side window. However, other embodiments within the scope of the present disclosure may include additional movable windows in other locations, such as an additional driver side window for a second row of seats, an additional passenger side window for a second row of seats, a sunroof, other window location, or any combination thereof. The first movable window 14 and second movable window 16 may comprise laminated window glass, a plastic material such as a polycarbonate, or any other suitable window material.

A first actuator 18 is coupled to the first window 14 and configured to selectively raise or lower the first window 14. A second actuator 20 is coupled to the second window 16 and configured to selectively raise or lower the second window 16.

The vehicle 10 includes an HMI 22 for receiving an operator request to open or close the first window 14 or second window 16. In various embodiments, the HMI 22 may include a physical interface such as a button or switch, a touchscreen display interface, a voice control interface, or any other suitable interface for receiving an operator request to open or close a window.

The vehicle 10 additionally includes at least one sensor 24. The sensor(s) 24 are configured to generate a signal in response to pressure variations. In an exemplary embodiment, the sensor(s) 24 include a microphone, such as are conventionally included in vehicles for telecommunication purposes or for voice control of vehicle systems. However, in other embodiments the sensor(s) 24 may include a strain gauge or accelerometer disposed in the vehicle cabin, or any other sensor suitable for generating a signal in response to pressure variations.

The first actuator 18, second actuator 20, HMI 22, and sensor(s) 24 are all in communication with or under the control of at least one controller 26. While depicted as a single unit, the controller 26 may include one or more additional controllers collectively referred to as a “controller.” The controller 26 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 26 is configured to, in response to an operator input to the HMI 22 requesting the first window 14 to be opened, control the first actuator 18 to open the first window 14. The controller 26 is additionally configured to automatically control the second actuator 20 based on signals from the sensor 24, as will be discussed in further detail below.

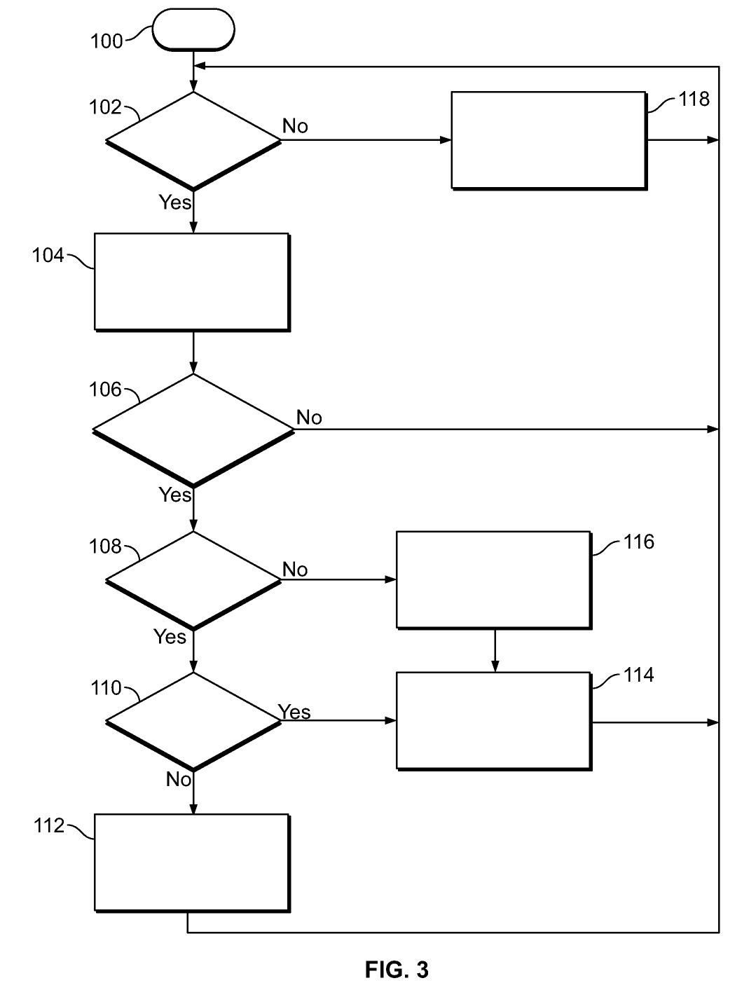

Referring now to FIG. 3, a method of controlling a window system according to an embodiment of the present disclosure is illustrated in flowchart form. In an exemplary embodiment, the method illustrated in FIG. 3 is performed by a controller configured similarly to the controller 26 in FIG. 2, e.g. a controller in communication with a sensor configured to detect pressure variations in the cabin and generate a signal based on the detected pressure variations. The algorithm begins at block 100, e.g. at the beginning of a drive cycle.

A determination is made of whether a first movable window is open, as illustrated at operation 102. The first movable window may be automatically opened in response to a request transmitted via an HMI, as discussed above. The first movable window may be a side window, sunroof, aft window, or any other movable window to the cabin of the vehicle.

If the determination of operation 102 is positive, then a current amplitude Aₜ of pressure variations within the cabin is determined, as illustrated at block 104. In an exemplary embodiment, Aₜ is a filtered value referring to the maximum amplitude of pressure variations within a given frequency range, e.g. low frequencies such as those below 50 Hz, measured by the sensor.

A determination is made of whether a difference Eₜ between the current amplitude Aₜ and a reference amplitude A_{ref} is greater than zero, as illustrated at operation 106. In an exemplary embodiment, the reference amplitude A_{ref} is provided by a vehicle manufacturer based on a comfortable decibel level within the frequency range of interest. In an alternative embodiment, the pressure variation threshold may be defined by an operator of the vehicle, e.g. via an HMI. In an exemplary embodiment, the difference Eₜ may be calculated via a PID controller.

If the determination of operation 106 is negative then control returns to operation 102. The algorithm thereby does not proceed unless the current amplitude of pressure variations within the cabin exceeds a reference value.

If the determination of operation 106 is positive, i.e. that the current amplitude Aₜ exceeds the reference amplitude A_{ref}, then a determination is made of whether the difference Eₜ is less than a stored difference Eₜ₋₁, as illustrated at operation 108. The stored difference Eₜ₋₁ refers to a difference calculated during the previous iteration of the algorithm. Stated differently, at operation 108 a determination is made of whether the amplitude Aₜ is reduced relative to the previous iteration of the algorithm.

If the determination of operation 108 is positive, then a determination is made of whether a second movable window is opened a maximum actuatable distance, as illustrated at operation 110. The second movable window may be a side window, sunroof, aft window, or any other movable window aside from the first window. The maximum actuatable distance refers to the maximum distance to which an actuator associated with the second window is permitted to open the second window. This may be determined based on the window configuration, software limits imposed by the manufacturer, operator-provided settings, any other suitable limitation, or a combination thereof. The determination may be made based on a signal from a sensor, e.g. an encoder, associated with the actuator associated with the second window.

If the determination of operation 110 is negative, then the second window is automatically opened a predefined distance as illustrated at block 112. In an exemplary embodiment, this is performed by controlling the actuator associated with the second window to open the second window the predefined distance. In an exemplary embodiment, the predefined distance is less than a full actuatable range of the window, and may be a relative small fraction thereof. Control then returns to operation 102.

As may be seen, the algorithm may thereby increment a second window open, so long as doing so continues to reduce the difference between a measured amplitude of pressure variations and the reference amplitude.

Returning to operation 110, if the determination is positive, i.e. the second window is opened to a maximum actuatable distance, then an additional mitigation action is performed, as illustrated at block 114. In an exemplary embodiment, the additional mitigation action includes incrementing one or more additional windows open in a similar fashion to that described in conjunction with steps 104 through 112. The algorithm may thereby incrementally adjust the position of a plurality of vehicle windows to mitigate a buffeting effect from the first window being open. In an alternative embodiment, the additional mitigation action includes at least partially closing the first window to mitigate the buffeting effect. Control then returns to operation 102.

Returning to operation 108, if the determination is negative, i.e. the difference Eₜ is equal to or greater than the stored difference Eₜ₋₁, then the second window is automatically closed the predefined distance, i.e. to the window position from the previous iteration of the algorithm. The second window is thereby controlled to the position at which a minimum amplitude is detected. Control then proceeds to block 114 to perform additional mitigation action as discussed above.

Returning to operation 102, if the determination of operation 102 is negative, i.e. the first window has been closed, then any windows which have been automatically opened according to the algorithm are automatically closed, as illustrated at block 118. The algorithm thereby ensures that the second window and any other windows which have been opened for buffeting mitigation are closed when the first window is closed.

As may be seen, embodiments according to the present disclosure provides a system and method for automatically mitigating buffeting caused by opening of a window in an automotive vehicle, thereby increasing occupant satisfaction.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
an occupant cabin having a first opening and a second opening;
a first movable window selectively covering the first opening and having a first closed position and a first open position;
a second movable window selectively covering the second opening;
a first actuator configured to selectively actuate the first movable window between the first closed position and the first open position;
a second actuator configured to selectively actuate the second movable window in a second window open direction and in a second window closed direction;
a sensor disposed in the cabin and configured to generate a signal in response to pressure variations;
an HMI configured to receive a window open request from an operator; and
a controller in communication with the HMI, the controller being configured to, in response to the window open request, control the first actuator to actuate the first movable window from the first closed position to the first open position, and in response to the signal from the sensor indicating pressure variations exceeding a predefined threshold with the first movable window in the first open position, automatically control the second actuator to actuate the second movable window in the second window open direction.

2. The vehicle of claim 1, wherein the controller is further configured to, subsequent controlling the second actuator to actuate the second movable window in the second window open direction, in response to the signal from the sensor continuing to indicate pressure variations exceeding the predefined threshold, automatically control the second actuator to further actuate the second movable window in the second window open direction.

3. The vehicle of claim 1, further comprising:
a third movable window selectively covering a third opening; and
a third actuator configured to selectively actuate the third movable window in a third window open direction and in a third window closed direction, wherein the controller is further configured to, subsequent controlling the second actuator to actuate the second movable window in the second window open direction, in response to the signal from the sensor continuing to indicate pressure variations exceeding the predefined threshold, automatically control the third actuator to actuate the third movable window in the third window open direction.

4. The vehicle of claim 1, wherein the controller is further configured to, subsequent controlling the second actuator to actuate the second movable window in the second window open direction, in response to the signal from the sensor continuing to indicate pressure variations exceeding the predefined threshold, automatically control the first actuator to actuate the first movable window to the closed position.

5. The vehicle of claim 1, wherein the sensor includes a microphone.

6. The vehicle of claim 1, wherein the first movable window is a first side window and the second movable window is a second side window.

7. A method of controlling a vehicle, comprising:
providing a sensor configured to detect pressure variations in a vehicle cabin, an actuator configured to control a position of a first vehicle window, and a controller in communication with the sensor and the actuator;
detecting, via the sensor, pressure variations exceeding a predefined threshold; and
in response to detected pressure variations exceeding the predefined threshold and to a second vehicle window being in an open position, automatically controlling the actuator, via the controller, to open the first vehicle window a predefined distance.

8. The method of claim 7, further comprising, in response to detected pressure variations exceeding the predefined threshold subsequent the first vehicle window opening the predefined distance, automatically controlling the actuator, via the controller, to open the first vehicle window an additional distance.

9. The method of claim 8, further comprising, in response to detected pressure variations increasing subsequent the first vehicle window opening the additional distance, automatically controlling the actuator, via the controller, to close the first vehicle window the additional distance.

10. The method of claim 7, further comprising:
providing an additional actuator configured to control a position of a third vehicle window; and
in response to detected pressure variations exceeding the predefined threshold subsequent the first vehicle window opening the predefined distance, automatically controlling the additional actuator, via the controller, to open the third vehicle window a predefined distance.

11. The method of claim 7, further comprising:
providing an additional actuator configured to control a position of the second vehicle window; and
in response to detected pressure variations exceeding the predefined threshold subsequent the first vehicle window opening the predefined distance, automatically controlling the additional actuator, via the controller, to close the second vehicle window a predefined distance.

12. The method of claim 7, wherein providing a sensor includes providing a microphone.

13. A controller for a window assembly for a vehicle, the controller being programmed to:
receive a first signal from a sensor;
determine a first pressure variation amplitude based on the first signal; and
in response to the first pressure variation amplitude exceeding a reference amplitude, communicate a first control signal to an actuator for actuation of a vehicle window.

14. The controller of claim 13, wherein the controller is programmed to determine the first pressure variation amplitude based on the first signal by filtering the first signal for a desired frequency range.

15. The controller of claim 13, wherein the controller is programmed to communicate the first control signal in further response to a window position signal indicating a second vehicle window being in an open position.

16. The controller of claim 13, wherein the first control signal includes a command to open a vehicle window.

17. The controller of claim 16, wherein the controller is further programmed to:
receive a second signal from the sensor subsequent communicating the first control signal;
determine a second pressure variation amplitude based on the second signal; and
in response to the second pressure variation amplitude exceeding the reference amplitude, communicate a second control signal including a second command to open a vehicle window.

18. The controller of claim 16, wherein the controller is further programmed to:
receive a second signal from the sensor subsequent communicating the first control signal;
determine a second pressure variation amplitude based on the second signal; and
in response to the second pressure variation amplitude exceeding the first pressure variation amplitude, communicate a second control signal including a command to close a vehicle window.
